(19) United States
(12) Patent Application Publication
(10) Pub. No.: US 2026/0253464 A1
(43) Pub. Date: Aug. 27, 2026

(54) STEERING CONTROL APPARATUS AND METHOD

(71) Applicant: HL MANDO CORPORATION, Pyeongtaek-si (KR)

(72) Inventor: Junho SHIN, Pyeongtaek-si (KR)

(73) Assignee: HL MANDO CORPORATION, Pyeongtaek-si (KR)

(21) Appl. No.: 19/548,054

(22) Filed: Feb. 24, 2026

(30) Foreign Application Priority Data
Feb. 25, 2025 (KR) 10-2025-0024655
Jan. 19, 2026 (KR) 10-2026-0009846

(51) Int. Cl. G07C 5/08; G07C 5/00; G07C 5/10

(52) U.S. Cl. CPC G07C 5/0808; G07C 5/006; G07C 5/10

(57) ABSTRACT

A steering control apparatus is disclosed. The steering control apparatus includes a data acquirer configured to obtain raw data sensed from a plurality of sensors, and a controller configured to select sensor data required for state diagnosis of a specific device or a specific part of a vehicle among the raw data. The controller inputs at least one piece of the selected sensor data into at least one state diagnosis model to derive respective state feature data for the specific device or the specific part, and generate a diagnosis result for the specific device or the specific part based on the respective state feature data.

### CROSS-REFERENCE TO RELATED APPLICATIONS

This application claims the priority of Korean Patent Application No. 10-2025-0024655 filed on February 25, 2025, and the priority of Korean Patent Application No. 10-2026-0009846 filed on January 19, 2026, in the Korean Intellectual Property Office, the disclosure of which is incorporated herein by reference.

### BACKGROUND

### Technical Field

The present embodiments relate to a steering control apparatus and method for assisting a driver’s steering.

### Description of the Related Art

Various parts including consumables, and devices or systems implemented by the various parts, exist within an automobile. For the management of a vehicle where such parts/devices/systems must operate in a complex and organic manner, a mechanic at a vehicle repair shop must individually check the states of all parts of the automobile. Therefore, there are disadvantages in that vehicle management takes a long time and maintenance costs increase.

As conventional vehicle management technologies, there exist technologies that detect the remaining amount of fuel or engine temperature via a dashboard in the vehicle to inform of engine abnormalities, or technologies that display whether an airbag can operate normally.

### BRIEF SUMMARY

However, most existing diagnostic technologies of the related art remain limited to simple monitoring systems based on threshold comparison methods. As a result, they respond sensitively to sensor noise or external environmental changes such as temperature, humidity, and road surface conditions, making it difficult to accurately determine actual performance degradation or potential component failures. In addition, because vehicle diagnostics are typically performed using data collected at periodic maintenance intervals, real time monitoring of component condition during driving is limited and early abnormal signs are not readily detected. Consequently, maintenance measures are commonly taken only after failure symptoms appear.

In view of the foregoing, the present disclosure provides a steering control apparatus and method configured to obtain sensor data from sensors mounted on a vehicle in real-time, diagnose a state of a specific device or component based on the obtained data, and generate a control signal according to the diagnosis result.

In order to solve one or more technical problems in the related art, including the above-identifed problems, in one aspect, the present disclosure may provide a steering control apparatus comprising: a data acquirer configured to obtain raw data sensed from a plurality of sensors; and a controller configured to select sensor data required for state diagnosis of a specific device or a specific part of the vehicle among the raw data, input at least one piece of the selected sensor data into at least one state diagnosis model to derive respective state feature data for the specific device or the specific part, and generate a diagnosis result for the specific device or the specific part based on the respective state feature data.

In another aspect, the present disclosure may provide a steering control method comprising: obtaining raw data sensed from a plurality of sensors; selecting sensor data required for state diagnosis of a specific device or a specific part of a vehicle among the raw data; inputting at least one piece of the selected sensor data into at least one state diagnosis model to derive respective state feature data for the specific device or the specific part, and generating a diagnosis result for the specific device or the specific part based on the respective state feature data.

In another aspect, the present disclosure may provide a vehicle control apparatus comprising: at least one memory storing computer program instructions; and at least one processor configured to execute the computer program instructions, wherein execution of the computer program instructions by the at least one processor causes the at least one processor to: obtain raw data sensed from a plurality of sensors, select sensor data required for state diagnosis of a specific device or a specific part of a vehicle among the raw data, input at least one piece of the selected sensor data into at least one state diagnosis model to derive respective state feature data for the specific device or the specific part, and generate a diagnosis result for the specific device or the specific part based on the respective state feature data.

As described above, according to the present disclosure, the steering control apparatus and method can secure accurate sensor signals by removing noise through adaptive filtering.

In addition, the present disclosure can more accurately determine both short-term anomalies and long-term patterns by using Random Forest, which is a traditional machine learning technique, and LSTM, which is a deep learning technique, in parallel.

In addition, the present disclosure can provide a user with replacement timing and part abnormality cause information based on predicted lifespan data.

Furthermore, the present disclosure can automatically update model accuracy through data retraining linked with a cloud where vehicle sensor data is stored.

### BRIEF DESCRIPTION OF THE SEVERAL VIEWS OF THE DRAWINGS

The above and other aspects, features and other advantages of the present disclosure will be more clearly understood from the following detailed description taken in conjunction with the accompanying drawings, in which:

FIG. 1 is a block diagram schematically showing a steering control system according to an embodiment.

FIG. 2 is a block diagram for briefly explaining a steering control apparatus according to an embodiment of the present disclosure.

FIG. 3 is a block diagram of a steering control apparatus according to another embodiment.

FIG. 4 is a flowchart explaining a steering control method according to an embodiment of the present disclosure.

FIG. 5 is a diagram for explaining step S420 according to an embodiment in more detail.

FIG. 6 is a flowchart for explaining generating a diagnosis result according to an embodiment.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements, etc., but is used merely to distinguish the corresponding element from other elements.

When it is mentioned that a first element “is connected or coupled to”, “contacts or overlaps”, etc., a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc., each other via a fourth element. Here, the second element may be included in at least one of two or more elements that “are connected or coupled to”, “contact or overlap”, etc., each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes, etc., are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

The present disclosure describes a steering control apparatus in which a diagnostic inference pipeline operates continuously together with steering actuation rather than as an offline maintenance or threshold monitoring function. Raw multi sensor vehicle data is selectively extracted according to diagnostic relevance and event triggers, processed to remove noise, and provided to parallel machine learning models to generate state features representing component health. The resulting diagnosis directly influences steering behavior, including failure alerts, operational restriction, maintenance timing, and fail operational control such as switching to a redundancy motor to preserve steering authority.

The apparatus combines different diagnostic perspectives by using a statistical model such as Random Forest to identify correlation based anomalies and a temporal deep learning model such as LSTM (Long Short-Term Memory) to detect degradation patterns over time, and the outputs are weighted or reconciled to produce a unified diagnosis. The system also adapts computation by selecting relevant sensor inputs using mapping tables, feature extraction techniques, or trigger conditions including temperature changes, current spikes, or steering dynamics, which enables real time prognostics within an electronic control unit. Rather than providing only a fault classification, the controller generates quantitative health features such as abnormality probability and remaining useful life.

The apparatus also operates within a learning loop in which vehicle data may be stored locally or uploaded to a cloud service, retrained models are returned to the vehicle, and diagnostic accuracy improves through fleet operation. The contribution therefore lies in the structured integration of adaptive sensing, prognostics, safety related control modification, and ongoing model refinement within a steering controller.

Hereinafter, a steering control system 1 according to an embodiment will be described with reference to the accompanying drawings.

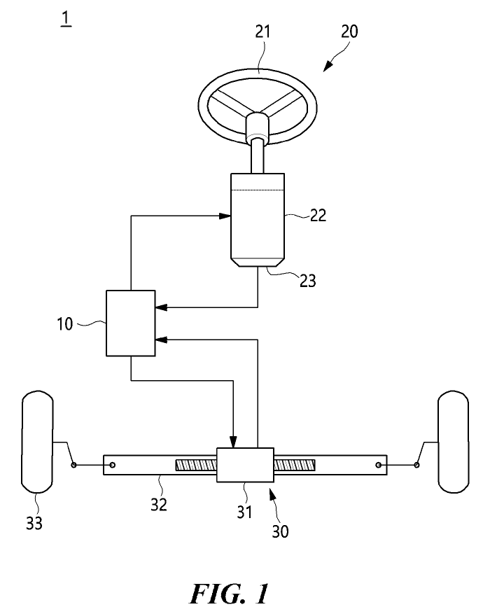

FIG. 1 is a block diagram schematically showing a steering control system 1 according to an embodiment.

Referring to FIG. 1, the steering control system 1 according to an embodiment may include a steering control apparatus 10, a Steering Feedback Actuator (SFA) 20, a Road Wheel Actuator (RWA) 30, and the like.

The steering control system 1 according to an embodiment may refer to a system that controls the steering of a host vehicle equipped with the steering control system 1 to change according to a steering angle of a steering wheel 21 operated by a driver.

This steering control system 1 may be a Steer-by-Wire (SbW) system that transmits power by transmitting and receiving electrical signals via wires, cables, etc., instead of a mechanical connection member (or linkage) between a steering input actuator and a steering output actuator. Hereinafter, the steering control system 1 will be described based on the SbW system, but is not limited thereto.

In the steering control system 1, based on steering information input by a sensor and a steering module mounted on the SFA 20, the steering control apparatus 10 determines a final steering direction of the vehicle and may output a command current to the RWA 30 so that the vehicle steers in the steering direction.

As described above, when the steering control system 1 is an SbW system, the SFA 20 and the RWA 30 may be mechanically separated.

The SFA 20 may refer to a device into which steering information intended by the driver is input. As described above, the SFA 20 may include the steering wheel 21, a steering shaft 22, and a reaction force motor 23. In addition, although not shown, a steering gear that transmits the rotational force of the reaction force motor 23 to the steering shaft 22 may be further included.

The steering wheel 21 may rotate between a left steering lock end and a right steering lock end with the steering shaft 22 as a rotation axis. Here, the lock end may refer to a limit point to which the steering wheel can move. The lock end may be configured with a steering damper or the like.

The reaction force motor 23 may receive a control signal (or referred to as a command current) from the steering control apparatus 10 and provide feedback torque to the steering wheel 21. In an embodiment, the reaction force motor 23 may receive a command current from the steering control apparatus 10, drive at a rotation speed indicated by the command current to generate feedback torque, and transmit the feedback torque to the steering wheel 21 through a worm and a worm wheel.

The SFA 20 may include a steering angle sensor detecting the steering angle of the steering wheel, a torque sensor detecting driver torque, a current sensor detecting the current of the reaction force motor 23, and a steering angular velocity sensor detecting the steering angular velocity of the steering wheel.

The steering control apparatus 10 may receive steering information from each sensor included in the SFA 20, calculate a control value, and output an electrical signal indicating the control value to the RWA 30. Here, the steering information may mean information including at least one of a steering angle, a steering angular velocity, and driver torque.

Meanwhile, the steering control apparatus 10 may receive feedback on actual output power information (e.g., rack position information) from the RWA 30, calculate a control value, and output an electrical signal indicating the control value to the SFA 20, thereby providing a steering feeling to the driver.

The RWA 30 may refer to a device that drives the actual vehicle to steer. Such an RWA 30 may include a steering motor 31, a rack 32, wheels 33, a vehicle speed sensor, a rack position sensor, and the like.

Further, the SFA 20 and the RWA 30 may further include a motor torque sensor capable of detecting motor torques of the reaction force motor 23 and the steering motor 31.

The steering motor 31 may move the rack 32 in an axial direction. Specifically, the steering motor 31 may drive by receiving a command current from the steering control apparatus 10

and cause the rack 32 to linearly move in the axial direction. That is, the rack 32 may linearly move between a left lock end, which is a left movement limit point, and a right lock end, which is a right movement limit point.

The rack 32 may perform a linear motion by the driving of the steering motor 31, and the wheels 33 may be steered to the left or right through the linear motion of the first rack 32.

In addition, the steering control system 1 according to the present embodiment may further include a redundancy motor (not shown) to ensure fail-safety and system redundancy. The redundancy motor may be physically separated from the steering motor 31 or implemented in a dual-winding form within a single housing to prepare for an emergency situation where the steering motor 31 cannot operate as a main motor. Specifically, when the controller determines that a failure or loss of function has occurred in the steering motor 31 based on a diagnosis result, it may control to immediately cut off power supply to or deactivate the steering motor 31 and hand over control authority to the redundancy motor to continuously provide steering assist force. Through this, the present disclosure can prevent a steering inability state (Lock) and maintain the driver’s steering control authority even if a failure of the main motor occurs during an autonomous driving situation or high-speed driving.

Although not shown, the steering control system 1 may further include a clutch capable of separating or combining the SFA 20 and the RWA 30, and respective temperature sensors capable of detecting temperatures of the reaction force motor 23, the PCB board of the steering control apparatus 10, and the steering motor 31. Here, the clutch operates under the control of the steering control apparatus 10, and the steering control apparatus 10 may obtain sensor data from each temperature sensor.

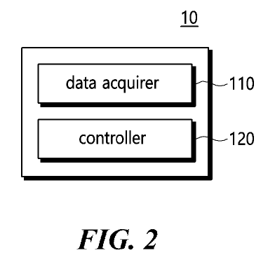

FIG. 2 is a block diagram for briefly explaining the steering control apparatus 10 according to an embodiment of the present disclosure.

Referring to FIG. 2, the steering control apparatus 10 of the present disclosure may include a data acquirer 110, a controller 120, and the like.

The steering control apparatus 10 may obtain raw data sensed from a plurality of sensors, select sensor data required for state diagnosis of a specific device or a specific part of a vehicle among the raw data, input at least one piece of the selected sensor data into at least one state diagnosis model to derive respective state feature data for the specific device or the specific part, and generate a diagnosis result for the specific device or the specific part based on the respective state feature data.

As used herein, the term “specific device or specific part” refers to a physical component or subsystem of a vehicle whose operating condition can be inferred from sensor data. The specific device or specific part may include, for example, an actuator, sensor, mechanical element, electrical component, or a combination thereof associated with vehicle control. Representative examples include steering system components such as a steering motor, reaction force motor, steering angle sensor, torque sensor, rack mechanism, and related driving circuitry, as well as other vehicle control components including brake system elements, temperature monitored devices, current driven actuators, or other components whose performance degradation, abnormal operation, or failure state can be determined from measured signals. The term is not limited to the listed examples and encompasses any vehicle hardware component for which a state diagnosis can be performed based on sensed data.

As used herein, “state feature data” refers to information generated by the state diagnosis model that quantitatively represents an operating condition of the specific device or specific part based on sensor signals. The state feature data may include one or more numerical values, a vector, a statistical parameter, a probability value, a health index, a degradation indicator, or a remaining useful life estimate derived from relationships, patterns, or temporal characteristics of the sensor data. The state feature data is distinct from raw sensor measurements and corresponds to processed diagnostic information indicating performance level, abnormal behavior tendency, or failure likelihood of the corresponding component.

The data acquirer 110 may obtain raw data sensed from a plurality of sensors mounted on the vehicle.

The raw data is unprocessed original data measured by each sensor and may be utilized as basic input values for diagnosing the state of a part or device of the vehicle. The raw data may include sensor data sensed by the plurality of sensors. The plurality of sensors may include a temperature sensor, a steering angle sensor, a torque sensor, a wheel steering angle sensor, a current sensor, and the like.

The data acquirer 110 may obtain raw data in real-time; for example, the data acquirer 110 may obtain steering torque, steering angle, device temperature, and current data sampled periodically (1ms to 10ms intervals).

The data acquirer 110 may transmit and receive data to and from each component of the vehicle using communication protocols such as CAN (Controller Area Network), LIN (Local Interface Network), FlexRay, MOST (Media Oriented Systems Transport), Ethernet, etc.

The controller 120 may select sensor data required for state diagnosis of a specific device or a specific part of the vehicle among the raw data, input at least one piece of the selected sensor data into a first state diagnosis model and a second state diagnosis model based on machine learning to derive respective state feature data for the specific device or the specific part, and generate a diagnosis result for the specific device or the specific part based on the respective state feature data.

The controller 120 may identify and selectively extract sensor data having high relevance to a diagnosis target device from the obtained raw data.

When diagnosing the state of the steering control system 1, the controller 120 selects data such as steering input torque, steering angle, motor current, motor temperature, etc., among raw data obtained from a steering torque sensor, angle sensor, current sensor, temperature sensor, etc. When diagnosing the state of a brake system, the controller 120 may selectively classify data such as brake pedal stroke, master cylinder pressure, vehicle deceleration, etc.

For example, the controller 120 may extract only necessary sensor data by referring to a predetermined data mapping table or algorithm for each diagnosis target, and exclude sensor data with low correlation or unnecessary for diagnosis, thereby reducing data throughput and improving calculation efficiency.

As another example, the controller 120 may select sensor data valid for state diagnosis of a specific device or a specific part of the vehicle by utilizing a feature extraction technique.

Specifically, the controller 120 may apply feature extraction algorithms such as PCA (Principal Component Analysis), CCA (Canonical Correlation Analysis), LDA (Linear Discriminant Analysis), etc., to identify sensor data having high correlation with the diagnosis target device among raw data obtained through an interface unit of the vehicle. These algorithms analyze statistical correlations or principal components between sensor data to preferentially select sensor data with high contribution to diagnosis and automatically exclude unnecessary or duplicated data.

For example, the controller 120 may preferentially select steering angle and current data, which result in high contribution according to PCA analysis, among multiple sensor data such as steering torque, steering angle, current, temperature, etc.

The controller 120 may select sensor data based on whether an event trigger of a specific device or a specific part occurs.

Specifically, the controller 120 monitors raw data collected from the plurality of sensors in real-time, and when an event trigger occurs in a specific device or a specific part, it may

be configured to preferentially select sensor data related to the corresponding trigger. Here, the event trigger may refer to a situation where the state of the diagnosis target device or part changes or exceeds a specific threshold condition.

For example, if the temperature of a specific device or a specific part is equal to or higher than a reference value, the controller 120 may determine that an event trigger has occurred.

As another example, if it is detected that current increases rapidly, for example, if a peak occurs in the driving current of a specific device or a specific part, the controller 120 may determine that an event trigger has occurred.

As another example, if the rate of change of the steering angle in steering torque increases rapidly, the controller 120 may determine that an event trigger has occurred.

The controller 120 may select sensor data obtained for a predetermined period. Then, the controller 120 may perform pattern analysis-based diagnosis utilizing the aforementioned sensor data. For example, the data acquirer 110 may store sensor data for the last 30 days inside the steering control apparatus 10 or transmit failure logs and long-term data to a cloud utilizing AWS IoT Core or Microsoft Azure.

According to the above, the controller 120 may detect abnormal changes over time in sensor data and generate a diagnosis result accordingly.

To this end, the data acquirer 110 may store raw data for a predetermined period. In addition, the data acquirer 110 may store the aforementioned raw data in an external server connected via a network, and if necessary, the controller 120 may reference the raw data from the external server.

In addition, the data acquirer 110 may be configured to include a communication module and a memory to implement transmission and storage of raw data.

In a vehicle driving environment, irregular noise is likely to occur in sensor signals due to various factors such as vibration, electromagnetic interference (EMI), temperature changes, etc. If entered into a diagnostic algorithm or machine learning model without such noise being removed, there is a problem that diagnostic accuracy deteriorates.

Therefore, in the present disclosure, in order to improve the signal quality of sensor data, the controller 120 may remove sensor noise by applying a predetermined algorithm to the selected sensor data.

Specifically, the controller 120 may apply an adaptive filtering method to the sensor data. The predetermined algorithm may include, for example, at least one of a Kalman filter, a Wavelet transform, or a Moving Average Filter. Also, the controller 120 may remove noise from

sensor data by combining at least two of the Kalman filter, the Wavelet transform, or the Moving Average Filter. Meanwhile, specific calculation processes and algorithms of the Kalman filter, Wavelet transform, and Moving Average Filter applied for removing noise from sensor data in the present disclosure follow known technologies widely known in the technical field to which the present disclosure pertains, and thus detailed descriptions thereof will be omitted.

According to the above, the controller 120 of the present disclosure can stably correct a signal containing noise by adjusting filter coefficients in real-time to minimize an error between an output signal of a sensor and a predicted signal.

The controller 120 can precisely determine the state of a specific device or a specific part by operating a plurality of state diagnosis models in parallel using the selected at least one sensor data.

Specifically, the controller 120 may input the selected sensor data into at least one state diagnosis model based on machine learning. For example, it may be input to a first state diagnosis model and a second state diagnosis model included in the state diagnosis model, respectively.

For example, the first state diagnosis model may be a machine learning model learned by a Deep Learning technique, and the second state diagnosis model may be a machine learning model learned by a Random Forest technique. The controller 120 may generate a diagnosis result based on respective state feature data derived from the first state diagnosis model and the second state diagnosis model.

The controller 120 may derive state feature data based on statistical characteristics of sensor data using a traditional machine learning algorithm, and derive state feature data reflecting pattern changes over time using a deep learning-based time-series learning model such as LSTM (Long Short-Term Memory) or CNN (Convolutional Neural Network).

The controller 120 may generate a comprehensive diagnosis result for a specific device or a specific part by comparing and correcting respective state feature data derived from the first state diagnosis model and the second state diagnosis model.

Here, the diagnosis result may include failure status, predictive maintenance, and recommended countermeasures for the specific device or the specific part. For example, the diagnosis result may involve performing real-time automatic diagnosis and, as a result thereof, performing a failure occurrence alarm, a service center visit recommendation, or an OTA update.

As another example, the diagnosis result may be calculated in the form of a determination value for normal or abnormal, an abnormality occurrence probability, or a Remaining Useful Life (RUL) prediction value.

The controller 120 may assign weights according to output reliabilities of the first state diagnosis model and the second state diagnosis model or combine the two results to generate a final determination value. For example, in a situation requiring real-time performance (inference speed), the result of the first state diagnosis model is preferentially reflected, and in a precise analysis step, the result of the second state diagnosis model is additionally considered to improve the accuracy of failure prediction.

According to the above, the steering control apparatus 10 of the present disclosure can reduce the possibility of misdiagnosis of a single model and simultaneously reflect the statistical characteristics and temporal patterns of sensor data, thereby diagnosing the state of a vehicle part or device more reliably. The diagnosis result may be stored in an external server.

The steering control apparatus 10 may further include an output unit for visualizing and outputting the diagnosis result so that the driver can recognize it. The output unit may receive a control signal from the controller 120 and output a diagnosis result, main data, user feedback, and a diagnosis report corresponding to the control signal to a display. Here, the main data may include, for example, a graph of temperature, current, and steering angle changes, and a state indication (normal, caution, failure state) of the diagnosis target device or part. The user feedback may include a detailed notification message such as, for example, ‘Usage is restricted for 2 minutes due to motor overheating’. The diagnosis report includes an error code such as ‘DTC XXXXX’, a diagnosis code and cause upon failure occurrence such as motor overheating or cooling system check required, and may include a periodic system state report such as ‘Average steering temperature for the last month: 65°C. No abnormality’.

In an embodiment, the steering control apparatus 10 may be implemented as a Micom or an ECU (Electric Controller Unit).

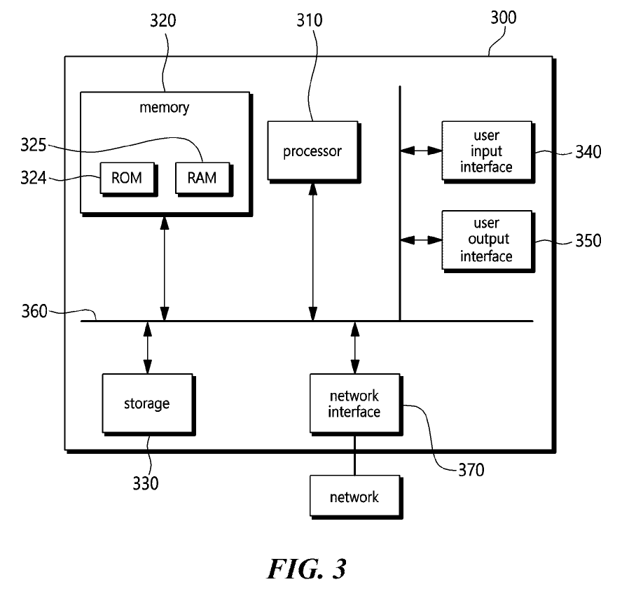

FIG. 3 is a block diagram of a steering control apparatus 10 according to another embodiment.

The embodiments of the present disclosure described above may be implemented within a computer system, for example, as a computer-readable recording medium. Referring to FIG. 3, a computer system 300 such as the steering control apparatus 10 may include at least one of one or more processors 310, a memory 320, a storage unit 330, a user interface input unit 340, and a user interface output unit 350, and they may communicate with each other via a bus 360. In addition, the computer system 300 may also include a network interface 370 for connecting to a network. The processor 310 may be a CPU or a semiconductor device that executes processing instructions stored in the memory 320 and/or the storage unit 330. The memory 320 and the storage unit 330 may include various types of volatile/non-volatile storage media. For example, the memory may include ROM 324 and RAM 325.

Hereinafter, a steering control method utilizing the steering control apparatus 10 capable of performing all of the above-described present disclosure will be described.

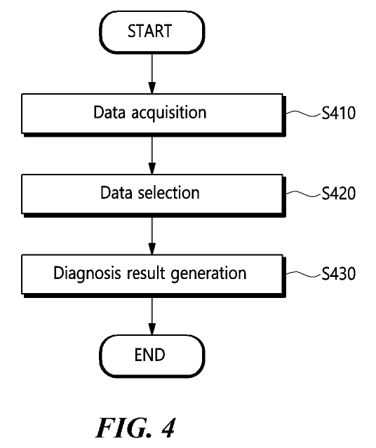

FIG. 4 is a flowchart explaining a steering control method according to an embodiment of the present disclosure.

Referring to FIG. 4, the steering control method according to an embodiment of the present disclosure may include obtaining (S410) raw data sensed from a plurality of sensors, selecting (S420) sensor data required for state diagnosis of a specific device or a specific part of a vehicle among the raw data, and inputting at least one piece of the selected sensor data into at least one state diagnosis model based on machine learning to derive respective state feature data for the specific device or the specific part, and generating (S430) a diagnosis result for the specific device or the specific part based on the respective state feature data.

The steering control apparatus 10 may store raw data for a predetermined period, and the steering control apparatus 10 may select sensor data obtained for a predetermined period.

The steering control apparatus 10 may select sensor data based on whether an event trigger of a specific device or a specific part occurs.

The steering control apparatus 10 may determine that an event trigger has occurred when the temperature of a specific device or a specific part is equal to or higher than a reference value associated with the specific device or the specific part or a peak occurs in the driving current of a specific device or a specific part.

The steering control apparatus 10 may remove sensor noise by applying a predetermined algorithm to the selected sensor data. The predetermined algorithm may include at least one of a Kalman filter, a Wavelet transform, or a Moving Average Filter.

The first state diagnosis model may be a machine learning model learned by a Deep Learning technique, and the second state diagnosis model may be a machine learning model learned by a Random Forest technique.

In an embodiment, the state feature data may not be simply an instantaneous value of a physical quantity measured by a sensor, but data quantifying the current state, performance level,

and degradation degree of the corresponding device or part by reflecting statistical characteristics, temporal patterns, cross-correlations, etc., of the sensor data.

Specifically, the state feature data is not a simple physical quantity extracted from sensor data, but as a result learned by a machine learning or deep learning model, it may be a high-dimensional feature vector quantitatively expressing the state, performance degradation degree, abnormal behavior characteristics, etc., of a specific device.

Here, the first state diagnosis model learns temporal patterns and change trends of time-series sensor data using deep learning algorithms such as LSTM (Long Short-Term Memory) or CNN (Convolutional Neural Network), and can output time-series-based state feature data reflecting signs of degradation or failure of a specific device.

The second state diagnosis model uses traditional machine learning algorithms such as Random Forest or SVM (Support Vector Machine) to analyze correlations and statistical distribution characteristics between sensor data, and can output statistics-based state feature data reflecting whether there is an abnormality in a specific device.

These two models independently generate state feature data expressing the state of the corresponding part or device from different analysis criteria (statistical/time-series perspectives), and each data is a result value derived from an output layer of the model and can output the state of the specific device in the form of a numerical value or vector.

The steering control apparatus 10 may generate a final diagnosis result of a specific device or a specific part by comparing and correcting or weight-combining a plurality of state feature data derived from the first state diagnosis model and the second state diagnosis model.

Accordingly, the diagnosis result may include failure status, predictive maintenance, and recommended countermeasures for the specific device or the specific part.

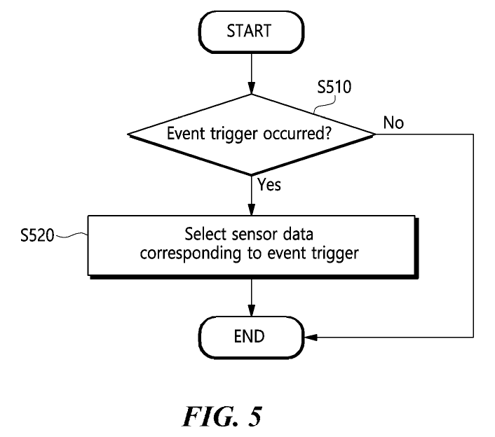

FIG. 5 is a diagram for explaining step S420 according to an embodiment in more detail.

Referring to FIG. 5, the steering control apparatus 10 may determine whether an event trigger of a specific device or a specific part has occurred (S510). The steering control apparatus 10 may select sensor data based on whether an event trigger of the specific device or the specific part occurs.

For example, the steering control apparatus 10 may determine that an event trigger has occurred when the temperature of a specific device or a specific part is equal to or higher than a reference value associated with the specific device or the specific part or a peak occurs in the driving current of a specific device or a specific part.

Therefore, when it is determined that an event trigger has occurred in a specific device or a specific part (Yes in S510), the steering control apparatus 10 may select sensor data required for state diagnosis of the specific device or the specific part corresponding to the event trigger (S520).

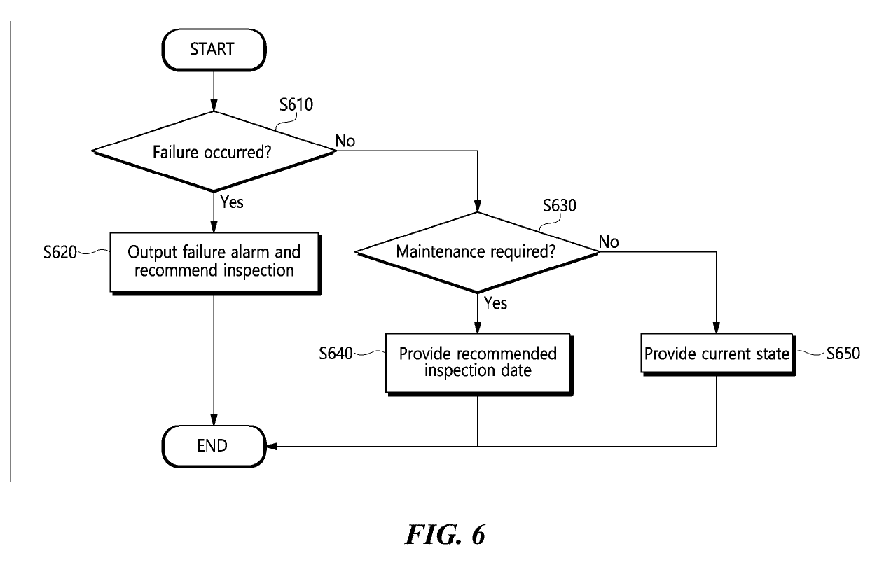

FIG. 6 is a flowchart for explaining generating a diagnosis result according to an embodiment.

Referring to FIG. 6, the steering control apparatus 10 may determine whether a failure has occurred in a specific device or a specific part (S610).

If it is determined that a failure has occurred in the specific device or the specific part (Yes in S610), the steering control apparatus 10 may output a failure alarm for the specific device or the specific part and recommend inspection (S620).

For example, if a sudden change in torque value occurs during steering, and the steering control apparatus 10 performs error diagnosis of a related sensor to determine whether there is a failure, and determines that it is a failure, it may provide information such as steering angle sensor inconsistency along with an error code through an output device in the vehicle.

If it is not a failure occurrence (No in S610), the steering control apparatus 10 may determine whether maintenance of the specific device or the specific part is required (S630).

If it is determined that maintenance is required (Yes in S630), the steering control apparatus 10 may provide a recommended inspection date for the specific device or the specific part (S640).

For example, if the motor temperature is maintained 10% higher than the average for the last 3 months, the steering control apparatus 10 determines that maintenance is required, and if maintenance is required, it may provide a motor replacement necessity timing calculated by a fatigue prediction model as a recommended inspection date.

If maintenance is not required (No in S630), the steering control apparatus 10 may provide the current state for the specific device or the specific part to be diagnosed (S650).

As described above, according to the present disclosure, the steering control apparatus and method can secure accurate sensor signals by removing noise through adaptive filtering.

In addition, the present disclosure can more accurately determine both short-term anomalies and long-term patterns by using Random Forest, which is a traditional machine learning technique, and LSTM, which is a deep learning technique, in parallel.

In addition, the present disclosure can provide a user with replacement timing and part abnormality cause information based on predicted lifespan data.

Furthermore, the present disclosure can automatically update model accuracy through data retraining linked with a cloud where vehicle sensor data is stored.

Meanwhile, the object recognition apparatus and/or object recognition method according to the present disclosure may be implemented by a vehicle control device.

For example, the vehicle control device may include at least one memory including computer program instructions and at least one processor executing the computer program instructions. The vehicle control device may be an electronic control unit including a semiconductor device such as an ECU or MCU.

Here, the at least one processor may obtain raw data sensed from a plurality of sensors, select sensor data required for state diagnosis of a specific device or a specific part of a vehicle from among the raw data, input the at least one selected sensor data into a first state diagnosis model and a second state diagnosis model based on machine learning to derive respective state characteristic data for the specific device or the specific part, and generate a diagnosis result for the specific device or the specific part based on the respective state characteristic data.

In addition, the at least one processor may apply a predetermined algorithm to the selected sensor data to remove sensor noise.

In addition, the at least one processor may select sensor data based on whether an event trigger of a specific device or a specific part has occurred.

In addition, the at least one processor may determine that an event trigger has occurred when the temperature of a specific device or a specific part is equal to or greater than a reference value.

In addition, the at least one processor may determine that an event trigger has occurred when a rapid increase in current is detected, for example, when a peak occurs in a driving current of a specific device or a specific part.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only.

That is, the disclosed embodiments are intended to illustrate the scope of the technical idea of the present disclosure. Thus, the scope of the present disclosure is not limited to the embodiments shown, but is to be accorded the widest scope consistent with the claims.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A steering control apparatus comprising:
a data acquirer configured to obtain raw data sensed from a plurality of sensors; and
a controller configured to:
select sensor data required for state diagnosis of a specific device or a specific part of a vehicle among the raw data,
input at least one piece of the selected sensor data into at least one state diagnosis model to derive respective state feature data for the specific device or the specific part, and
generate a diagnosis result for the specific device or the specific part based on the respective state feature data.

2. The steering control apparatus of claim 1, wherein the controller is configured to remove sensor noise by applying a predetermined algorithm to the selected sensor data.

3. The steering control apparatus of claim 2, wherein the predetermined algorithm comprises at least one of a Kalman filter, a Wavelet transform, or a Moving Average Filter.

4. The steering control apparatus of claim 1, wherein the at least one state diagnosis model comprises a first state diagnosis model which is a machine learning model learned by a Deep Learning technique and a second state diagnosis model which is a machine learning model learned by a Random Forest technique, and
wherein the controller is configured to generate the diagnosis result based on respective state feature data derived from the first state diagnosis model and the second state diagnosis model.

5. The steering control apparatus of claim 1, wherein the controller is configured to select the sensor data based on whether an event trigger of the specific device or the specific part occurs.

6. The steering control apparatus of claim 5, wherein the controller is configured to determine that the event trigger has occurred when a temperature of the specific device or the specific part is equal to or higher than a reference value associated with the specific device or the specific part or a peak occurs in a driving current of the specific device or the specific part.

7. The steering control apparatus of claim 1, wherein the data acquirer is configured to store the raw data for a predetermined period, and
wherein the controller is configured to select sensor data obtained for the predetermined period.

8. The steering control apparatus of claim 1, wherein the diagnosis result comprises information on whether a failure has occurred, predictive maintenance, and recommended countermeasures for the specific device or the specific part.

9. A steering control method comprising:
obtaining raw data sensed from a plurality of sensors;
selecting sensor data required for state diagnosis of a specific device or a specific part of a vehicle among the raw data;
inputting at least one piece of the selected sensor data into at least one state diagnosis model to derive respective state feature data for the specific device or the specific part, and
generating a diagnosis result for the specific device or the specific part based on the respective state feature data.

10. The steering control method of claim 9, wherein the generating the diagnosis result comprises removing sensor noise by applying a predetermined algorithm to the selected sensor data.

11. The steering control method of claim 10, wherein the predetermined algorithm comprises at least one of a Kalman filter, a Wavelet transform, or a Moving Average Filter.

12. The steering control method of claim 9, wherein the at least one state diagnosis model comprises a first state diagnosis model which is a machine learning model learned by a Deep Learning technique and a second state diagnosis model which is a machine learning model learned by a Random Forest technique, and
wherein the generating the diagnosis result comprises generating the diagnosis result based on respective state feature data derived from the first state diagnosis model and the second state diagnosis model.

13. The steering control method of claim 9, wherein the selecting sensor data comprises selecting the sensor data based on whether an event trigger of the specific device or the specific part occurs.

14. The steering control method of claim 13, wherein the selecting sensor data comprises determining that the event trigger has occurred when a temperature of the specific device or the specific part is equal to or higher than a reference value associated with the specific device or the specific part or a peak occurs in a driving current of the specific device or the specific part.

15. The steering control method of claim 9, wherein the obtaining raw data comprises storing the raw data for a predetermined period, and
wherein the selecting sensor data comprises selecting sensor data obtained for the predetermined period.

16. The steering control method of claim 9, wherein the diagnosis result comprises information on whether a failure has occurred, predictive maintenance, and recommended countermeasures for the specific device or the specific part.

17. A vehicle control apparatus comprising:
at least one memory storing computer program instructions; and
at least one processor configured to execute the computer program instructions,
wherein execution of the computer program instructions by the at least one processor causes the at least one processor to:
obtain raw data sensed from a plurality of sensors, select sensor data required for state diagnosis of a specific device or a specific part of a vehicle among the raw data,
input at least one piece of the selected sensor data into at least one state diagnosis model to derive respective state feature data for the specific device or the specific part, and
generate a diagnosis result for the specific device or the specific part based on the respective state feature data.

18. The vehicle control apparatus of claim 17, wherein the at least one processor is configured to remove sensor noise by applying a predetermined algorithm to the selected sensor data.

19. The vehicle control apparatus of claim 17, wherein the at least one processor is configured to select the sensor data based on whether an event trigger of the specific device or the specific part occurs.

20. The vehicle control apparatus of claim 19, wherein the at least one processor is configured to determine that the event trigger has occurred when a temperature of the specific device or the specific part is equal to or higher than a reference value associated with the specific device or the specific part or a peak occurs in a driving current of the specific device or the specific part.
